(19) United States
(12) Patent Application Publication
(10) Pub. No.: US 2009/0104437 A1
(43) Pub. Date: Apr. 23, 2009

(54) SCALABLE SILVER NANO-PARTICLE COLLOID

(76) Inventors: Michael Jeremiah Bortner, Blacksburg, VA (US); Jennifer Hoyt Lalli, Blacksburg, VA (US); Cora Webb Olson, Blacksburg, VA (US); Elizabeth Gladwin, Christiansburg, VA (US)

Correspondence Address: SHERR & VAUGHN, PLLC, 620 HERNDON PARKWAY, SUITE 200, HERNDON, VA, 20170, US

(21) Appl. No.: 12/253,309

(22) Filed: Oct. 17, 2008

Related U.S. Application Data
(60) Provisional application No. 60/980,752, filed on Oct. 17, 2007.

(51) Int. Cl. B32B 5/16; B01J 13/00

(52) U.S. Cl. 428/328; 516/98

(57) ABSTRACT

A method for synthesizing silver nano-particle colloid includes initiating formation of silver colloid nano-particles by combining a reduction solution and a silver nitrate solution in a container; and then stabilizing the silver colloid nano-particles by combining a stabilizing solution to the container. Thus a colloid can be produced using such a method and an electrostatic self assembly may be constructed using such a colloid.

The present application claims priority to U.S. Provisional Patent Application No. 60/980,752 (filed Oct. 17, 2007) which is hereby incorporated by reference in its entirety.

### BACKGROUND

Previous synthetic approaches to generating silver colloids have not been able to provide the colloids in large quantities (e.g., greater than about 500 mL). These approaches also generally require harsh chemical reaction preparation treatments, do not address details of chemical addition procedures, usually involve limited colloid stability and lifetime as a result of particle agglomeration, and often require reaction conditions other than ambient.

These approaches typically require strong acid or oxidizer glass treatments to etch away any potential contaminants in the reactor because these contaminants often provide sites for particle nucleation, ultimately resulting in a limited colloid lifetime (e.g., less than about 24 hours). Reasons for this limited lifetime include particle growth, agglomeration and precipitation out of the solution.

Because of these shortcomings, prior techniques involving silver nano-particle colloids in ESA have been restricted to substrates that measure less than about 3 in².

### SUMMARY

Embodiments relate to a method for synthesizing silver nano-particle colloid that includes initiating formation of silver colloid nano-particles by combining a reduction solution and a silver nitrate solution in a container; and then stabilizing the silver colloid nano-particles by combining a stabilizing solution to the container. Embodiments also relate to a colloid produced by this method and to electrostatic self assemblies constructed using such a colloid.

### DRAWINGS

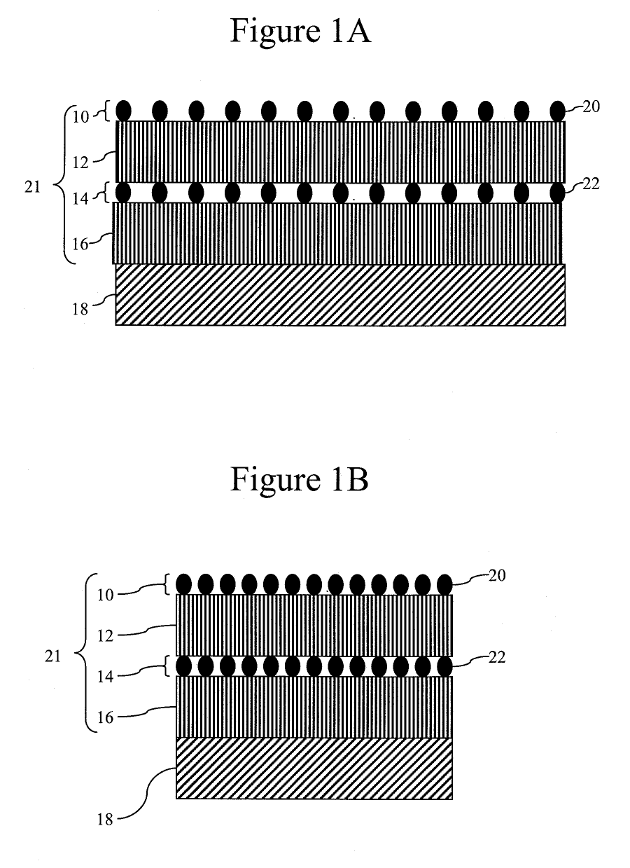

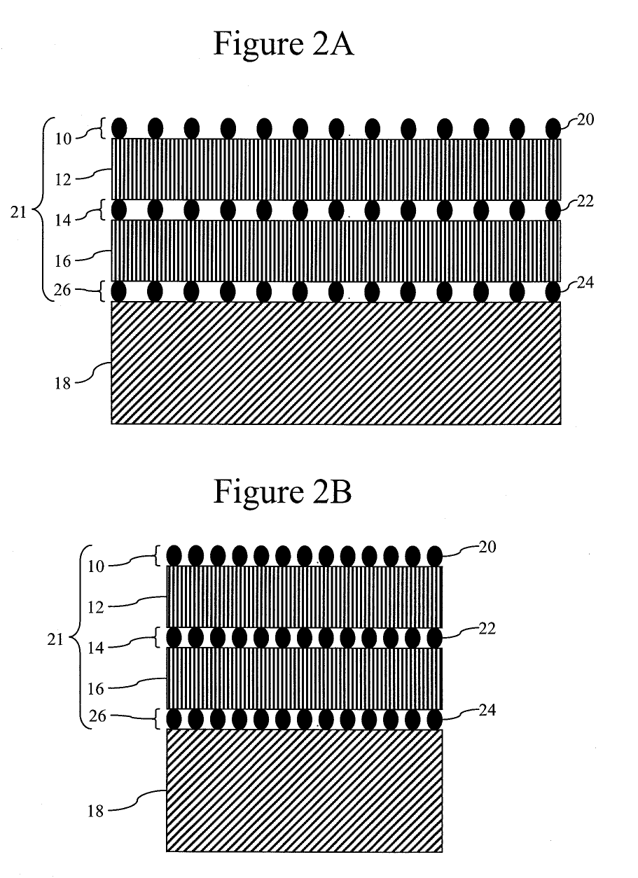

Example FIGS. 1A, 1B, 2A, and 2B illustrate a flexible conductive material formed on a flexible base material that have shrinkable and/or stretchable properties, in accordance with embodiments.

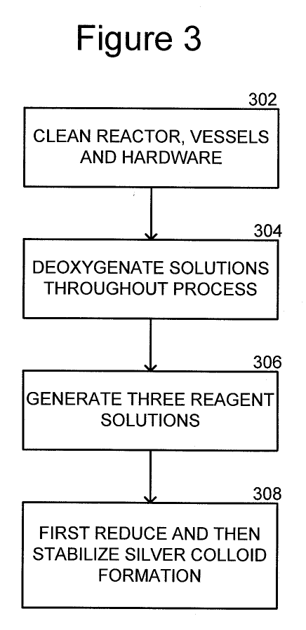

Example FIG. 3 depicts a flowchart of an example method for synthetic production of a silver colloid, in accordance to embodiments.

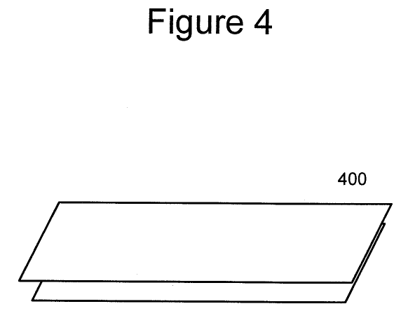

Example FIG. 4 illustrates a sheet or film comprising an electrostatic self-assembly that includes silver nano-particles, in accordance with embodiments.

### DESCRIPTION

Before describing a synthetic method capable of producing a silver colloid, in accordance with embodiments, a brief description of an Electrostatic self assembly (ESA) amenable to such a colloid is provided.

Example FIGS. 1A and 1B illustrate a flexible base material 18 with a flexible material layer 21 formed on the flexible base material 18 that have shrinkable and/or stretchable properties. Flexible material layer 21 includes nano-size (e.g., conductive or non-conductive) particles 20, 22 that do not substantially deteriorate due to shrinking of flexible base material 18, in accordance with embodiments. In accordance with embodiments, the nano-particles 20, 22 may be conductive and, in particular, silver particles resulting from the colloid synthesis method described later.

FIG. 1A illustrates first linking agent material layer 16 (of flexible material layer 21) bonded to flexible base material 18. First linking agent material layer 16 may be also bonded to first nano-particle material layer 14. First nano-particle material layer 14 may be also bonded to second linking agent material layer 12. Second linking agent material layer 12 may be also bonded to second nano-particle material layer 10. Although only two linking agent layers (i.e. first linking agent material layer 16 and second linking agent material layer 12) and two nano-particle material layers (i.e. first nano-particle material layer 14 and second nano-particle material layer 10) are illustrated, embodiments may include any number of linking agent material layers and nano-particle material layers (including just one nano-particle material layer and/or linking agent material layer).

In embodiments, the flexible material layer 21 may be formed directly on the flexible base material 18. The flexible material layer 21 may be substantially free standing, in embodiments. In embodiments, the flexible base material 18 may be supported by a rigid substrate and then removed from the rigid substrate after formation of the flexible material layer 21 (e.g. as a decal). In embodiments, the flexible base material 18 may be supported by a support structure (e.g. a frame, as illustrated in FIG. 5) during formation of the flexible material layer 21. By forming a flexible material layer on a flexible base material, fabrication and processing efficiency may be optimized.

First nano-particle material layer 14 includes nano-particles 22. In embodiments, nano-particles 22 may be conductive nano-particles (e.g. nano-size gold clusters). Nano-particles 22 may be individually bonded to first linking agent material layer 16. Bonding of nano-particles 22 to first linking agent material layer 16 may be either electrostatic bonding and/or covalent bonding. Nano-particles 22 may not be substantially bonded to each other. Accordingly, as first linking agent material layer 16 expands or contracts, the bond between the nano-particles 22 and first linking agent material layer 16 is not significantly compromised.

As illustrated in example FIG. 1B, an apparatus including flexible base material 18 and flexible material layer 21 may be shrunk or stretched. When shrunk, nano-particles 22 remain bonded to first linking material layer 16 as it is shrunk with the flexible base material 18. Since nano-particles 22 of first nano-particle material layer 14 are not bonded to each other, shrinking or stretching of first linking material layer 16 does not significantly compromise the robustness of first nano-particle material layer 14.

Although nano-particles 22 in first nano-particle material layer 14 are not bonded to each other, nano-particles 22 may be arranged close enough to each other, such that they may be electrically coupled to each other. In other words, in embodiments, electrical current may flow between adjacent nano-particles 22 in first nano-particle material layer 14. In fact, in embodiments, the rate of electrical conduction (i.e. electrical resistance) in first nano-particle material layer 14 (e.g. including gold nano-clusters) may be comparable and/or exceed that of solid gold (due to lattice inefficiencies in solid gold). Shrinking or stretching of first linking material layer 16 may increase (or decrease) the conductivity of first nano-particle material layer 14 (due to a decrease or increase in distance between neighboring nano-particles 22).

Shrinking and stretching may be accomplished by mechanical, electrical, thermal, and/or light stimulus.

Second linking agent material layer 12 may also be bonded to first nano-particle material layer 14, with the same or similar bonding mechanism as the bonding between first nano-particle material layer 14 and first linking agent material layer 16, in accordance with embodiments. In embodiments, first linking agent material layer 16 and second linking agent material layer 12 may include the same material and/or configuration. In embodiments, first linking agent material layer 16 and second linking agent material layer 12 may include different materials and/or configurations.

Second nano-particle material layer 10 may be bonded to second linking agent material layer 12 with the same or similar bonding mechanism as the bonding between first nano-particle material layer 14 and first linking agent layer 16. Additional linking agent material layer(s) and/or nano-particle material layer(s) may be formed over second nano-particle material layer 10, in accordance with embodiments. In embodiments, first nano-particle material layer 14 and second nano-particle material layer 10 may include the same material (i.e. nano-particles 20 and nano-particles 22 may be the same type of nano-particles) and/or configuration. In embodiments, first nano-particle material layer 14 and second nano-particle material layer 10 may include different materials (i.e. nano-particles 20 and nano-particles 22 may be different types of nano-particles) and/or configurations.

As illustrated in example FIGS. 2A and 2B, a nano-particle material layer (e.g. third nano-particle material layer 26 with nano-particles 24) may be formed between first linking agent layer 16 and flexible base material 18. In other words, in embodiments, a flexible base material may be bonded directly with a nano-particle material layer (e.g. third nano-particle material layer 26) or indirectly through a linking agent layer (e.g. first linking agent layer 18).

In embodiments, a flexible base material and linking agent material layer(s) may have the same, similar, and/or compatible elastic properties. In other words, when flexible base material is deformed through stress, straining, or shrinking, the elasticity of linking agent material layer(s) may not prevent a flexible base material from deforming since it is elastically compatible with the flexible base material. Since nano-particle material layer(s) include individual nano-particles that are independently bonded to an adjacent flexible base material and/or linking agent material layer(s), nano-particle material layer(s) may not prevent a flexible base material from deforming, in accordance with embodiments. Further, during deformation of a flexible base material, nano-particle material layers may not be subjected to significant mechanical strain, since there is substantially no bonding between adjacent nano-particles in the nano-particle material layer(s), in accordance with embodiments.

Nano-particles (e.g. nano-particles 20, nano-particles 22, and/or nano-particles 24) may be formed through a self-assembly, in accordance with embodiments. U.S. patent application Ser. No. 10/774,683 (filed Feb. 10, 2004 and titled “RAPIDLY SELF-ASSEMBLED THIN FILMS AND FUNCTIONAL DECALS”) is hereby incorporated by reference in its entirety. U.S. patent application Ser. No. 10/774,683 discloses self-assembly of nano-particles, in accordance with embodiments. In embodiments, the size (i.e. diameter or substantial diameter) of the nano-particles may be less than approximately 1000 nanometer. In embodiments, the size of the nano-particles may be less than approximately 50 nanometers. In embodiments, nano-particles may be gold and/or gold clusters. However, in other embodiments, nano-particles may be other metals (e.g. silver, palladium, copper, or other similar metal) and/or metal clusters. In embodiments, nano-particles may include metals, metal oxides, inorganic materials, organic materials, and/or mixtures of different types of materials. In embodiments, nano-particles may be semiconductor materials or non-conductive materials.

Through self assembly, nano-particles may be substantially uniformly and/or spatially dispersed during deposition to form a self assembled film, in accordance with embodiments. The self assembly of nano-particles may utilize electrostatic and/or covalent bonding of the individual nano-particles to a host layer (e.g. a linking agent material layer and/or a flexible base material). A host layer may be polarized in order to allow for the nano-particles to bond to the host layer, in accordance with embodiments. Since the deposition of the nano-particles may be dependent on individual bonding of the nano-particles to the host layer, a nano-particle material layer may have a thickness that is approximately the diameter of the individual nano-particles. Through a self-assembly deposition method, nano-particles that do not bond to a host layer may be removed, so that a nano-particles material layer is formed that is relatively uniform in thickness and material distribution.

Linking agent material layer(s) (e.g. first linking agent material layer 16 and/or second linking agent material layer 12) may be a material that is capable of covalently and/or electrostatically bonding to nano-particles, in accordance with embodiments. U.S. patent application Ser. No. 10/774,683 (which is incorporated by reference above) discloses examples of materials which may be included in linking agent material layer(s). Linking agent material layer(s) may include polymer material. In embodiments, the polymer material may include poly(urethane), poly(etherurethane), poly(esterurethane), poly(urethane)-co-(siloxane), poly(dimethyl-co-methylhydrido-co-3-cyanopropyl, methyl) siloxane, and/or other similar materials. Linking agent material layer(s) may include materials that are polarized, in order for bonding with nano-particles, in accordance with embodiments.

In embodiments, linking agent material layer(s) may include a flexible material, an elastic material, and/or an elastomeric polymer. Accordingly, when nano-particles are bonded to sites of material in a linking agent material layer, then the nano-particle material layer may assume the same elastic, flexible, and/or elastomeric attributes of the host linking agent material layer, in accordance with embodiments. This physical attribute may be attributed by the individual bonding of substantially each nano-particle (of a nano-particle material layer) to a site of the linking agent material layer through either covalent and/or electrostatic bonding. Accordingly, when a linking agent material layer is shrunk, stretched, strained, and/or deformed, bonded nano-particles will move with sites of the linking agent material layer to which they are bonded, thus avoiding any disassociation of the nano-particles from their host during deformation.

In embodiments, flexible base material 18 may include a shrinkable or stretchable material. For example, flexible base material 18 may include a shrinkable or stretchable polymer. An example of a shrinkable polymer is polyvinyl chloride polyethylene terephthalate (e.g. PVC/PET or “shrink wrap”) or a material with similar properties. In embodiments, flexible conductive material may first be formed on a shrinkable flexible base material 18 (e.g. FIGS. 1A and 2A) and then after formation of the flexible conductive material be shrunk (e.g. FIGS. 1B and 2B). As shown in FIGS. 1B and 2B, nano-particles 20, 22, and/or 24 become closer together after shrinking (compared to the distances between adjacent nano-particles in FIGS. 1A and 2A). Of course, the opposite would occur if the material where stretched instead. In embodiments, when the nano-particles become closer together due to shrinking, the electrical interaction between adjacent nano-particles increases, thus increasing conductivity. Accordingly, shrinking of the flexible base material may be an effective and/or efficient means to increase the conductivity of the flexible conductive layer.

Stretching would have an opposite effect. For example, the stretchable properties may allow flexible base material 18 to be stretched and/or strained by at least 1000% by mechanical, electrical, thermal, and/or light stimulus. In embodiments, a stretchable flexible base material (e.g. flexible base material 18) may include biaxially oriented polyethylene terephthalate material (e.g. Mylar) or a material with similar properties. In embodiments, flexible base material 18 may include a shape memory polymer.

Note that the thicknesses in FIGS. 1A, 1B, 2A, and 2B are shown for illustration and are not drawn to scale. In embodiments, the thickness of the flexible conductive layer is significantly less than the thickness of the flexible base material. Accordingly, since the material in the flexible base material and the flexible conductive material are elastically compatible, deformation, shrinking, and/or stretching of the flexible base material cause the flexible conductive material to comply with the flexible base material by deforming shrinking, and/or stretching.

Embodiments may be implemented in a wide range of applications, including, but not limited to highly conductive sensors (strain, pressure, chemical, temperature, etc.) protective packaging for electronics or electronic wiring enclosures, lightning strike protection films and textiles as laminates within composites, covering over paper, photographs, clothing or shelter vehicle textiles, clear protective overlays from the environment to prevent deterioration of sensitive documents; or conductive overlays where needed for mirror-like effect or ESD, EMI shielding, thermal and electrically insulating materials or textiles for windows, homes, clothing, space suits, shelters, vehicles, and inflatable vehicles via reflection, a base material for audio or video magnetic recording tapes, solar and marine applications in sails or hulls, kites and parachutes, electronic/acoustic applications such as electrostatic loudspeakers dielectric in foil capacitors, and morphing materials for aircraft.

In accordance with embodiments, the conductive nano-particles in the ESA structure described above may include silver nano-particles provided by a synthetic silver nano-particle colloid production process. FIG. 3 provides a flowchart of such a process in accordance with embodiments which may be used to produce up to 20 L of stable silver nano-particle colloid, and even more if desired. This approach allows control over the functionality, particle size, and zeta potential of the silver nano-particles within the silver colloid which translates into controlling the mechanical, thermal, and electrical properties of a thin film used in an ESA structure or other applications.

In accordance with embodiments of the synthetic procedure, a reactor is cleaned using soap and water followed by a thorough rinsing, in step 302. One example, commercially-available soap is Alconox although others may be used instead. Rinsing may be accomplished, for example, using high purity deionized water (e.g., resistance of at least about 18 megaohms).

Next, in step 304, an inert gas such as Argon or Nitrogen is purged high purity deionized water to generate the deoxygenated reagent solutions that are used. This technique helps inhibit oxidation of the colloid. The water is vigorously agitated during deoxygenation to release a significant amount of bound oxygen; such as for between about 5 minutes and about 30 minutes. In accordance with embodiments, deoxygenation is typically continued throughout the course of the reaction to maintain a blanket of inert gas over the colloid along with continued vigorous agitation.

No special environmental conditions are required when performing the synthetic procedure in accordance with embodiments. For example, a temperature between about 15 C and about 25 C with humidity between about 20% to about 75% is appropriate.

In accordance with embodiments, a constant rate addition procedure is used when adding chemical reagents to the reactor during synthesis. One example technique for controlling reagent addition rates includes using a positive displacement pump capable of controlling reagent addition rates between about 1.3 and about 130 mL/min.

In step 306 three reagent solutions are generated: a silver nitrate solution, a reduction solution (e.g., sodium borohydride) and a stabilizing solution (e.g., sodium citrate.) Using the three reagent solutions, the silver colloid solution is formed, in step 308. Effectively, the sodium borohydride solution, or similar solution, initiates the silver colloid nano-particle formation and reduction which is followed by stabilization with the sodium citrate (or similar) solution to maintain particle suspension. The stabilization solution may also participate in the reduction process, but to a limited extent in comparison to the reduction solution.

The colloids produced in accordance with the embodiments result in nano-particles with controlled diameters in the range of about 10 to about 100 nm and narrow size distribution. Zeta potentials in the range of about −10 to about −50 mV may be obtained depending on synthesis adjustments.

### EXAMPLE SYNTHESIS

This example synthesis provides merely one example of specific chemicals, specific amounts and specific conditions for performing the synthetic procedure. Other embodiments contemplate varying the conditions, chemicals, and amount; thus, embodiments are not limited to the specific example procedure described below.

Three reagent solutions are prepared for this reaction. A glass reactor large enough to accommodate all three solutions is equipped for overhead stirring. 19.25 volume equivalents of ultra high purity deionized water is added to the reactor and subsequently deoxygenated with an inert gas.

7 volume equivalent of ultra high purity deionized water is added to a first vessel equipped for magnetic stirring. Following the deoxygenation process, add 3.68 weight equivalents of silver nitrate and stir until reagents go into solution.

1.75 volume equivalents of ultra high purity deionized water is added to a second vessel equipped for magnetic stirring. Following deoxygenation, add 43 weight equivalents of sodium citrate and stir until reagents go into solution.

Add 1 weight equivalent of sodium borohydride to the reactor vessel containing the 19.25 volume equivalents of water.

Once the solutions are substantially homogenous, begin addition of the silver nitrate solution and the sodium citrate solution to the sodium borohydride solution. Both additions are performed at a constant rate, beneficially in the range of about 1 to about 5 mL/min.

Add about 0.87 volume equivalents of the silver nitrate solution at a selected addition rate. Concurrently, begin addition of 0.44 volume equivalents of the sodium citrate solution to the sodium borohydride solution (while continuing adding the silver nitrate solution).

When approximately 2.5 volume equivalents of the silver nitrate solution remains to be added, begin addition of the remaining sodium citrate solution. Following complete addition of all reagents to the reactor vessel, the resulting colloidal solution should stand for about 10 to about 30 minutes.

In accordance with embodiments, a synthetic method for production of a highly stable silver nano-particle colloid amenable for implementation into ESA, ink jet printing, solution casting, spray coating and other materials processing techniques has been described. Multiple cross-linking materials have been implemented to demonstrate ESA amenability. Several mercaptan and amine functional chemicals have been implemented, including 2-mercaptoethal, poly(allymine) hydrochloride, and poly(diallyl dimethyl) ammonium chloride). Multiple molecular weights of polymeric anions have been successfully implemented to self assemble thin films using the colloid developed in accordance with embodiments.

Silver colloids produced according to embodiments have been shown to be ESA amendable for thin film generation on multiple substrate sizes, ranging from about 1 to about 576 in such as the structure 400 of FIG. 4. Although larger or smaller substrates can equally be coating using such thin films. Films have also been successfully self-assembled onto substrates with double curvature and on such varied substrate materials as polycarbonate, acrylic, and borosilicate glass.

### ESA Example 1

Immerse a polycarbonate substrate in the silver colloid solution for about 60 minutes. Rinse the polycarbonate substrate in high purity deionized water. Immerse the substrate into a crosslinking agent solution of 2-mercaptoethanol. Following about 10 minutes of immersion, rinse the substrate and repeat the cycle until a desired film thickness is achieved.

### ESA Example 2

Immerse a polycarbonate substrate in the silver colloid solution for about 60 minutes. Rinse the polycarbonate substrate and then immerse the substrate into a crosslinking agent solution of poly(diallyl dimethyl) ammonium chloride for about 10 minutes. Rinse the substrate and then repeat the immersion cycle until a desired film thickness is achieved.

### ESA Example 3

Immerse a polycarbonate substrate in the silver colloid solution for about 60 minutes. Rinse the polycarbonate substrate and then immerse the substrate into a crosslinking agent solution of poly(allylamine hydrochloride) for about 10 minutes. Rinse the substrate and then repeat the immersion cycle until a desired film thickness is achieved.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for synthesizing silver nano-particle colloid, comprising:
initiating formation of silver colloid nano-particles by combining a silver nitrate solution and a reduction solution in a container; and
stabilizing the silver colloid nano-particles by combining a stabilizing solution to the container.

2. The method of claim 1, wherein the reduction solution comprises a deoxygenated reduction solution.

3. The method of claim 1, wherein the silver nitrate solution comprises a deoxygenated silver nitrate solution.

4. The method of claim 1, wherein the stabilizing solution comprises a deoxygenated stabilizing solution.

5. The method of claim 1, wherein the reduction solution reduces silver nitrate at a first rate and the stabilizing solution reduces silver nitrate at a second rate, the second rate being less than the first rate.

6. The method of claim 1, wherein the reduction solution comprises sodium borohydride.

7. The method of claim 1, wherein the stabilizing solution comprises sodium citrate.

8. The method of claim 1, wherein the reduction solution is added at a substantially constant rate.

9. The method of claim 1, wherein the stabilizing solution is combined at a substantially constant rate.

10. The method of claim 1, wherein the initiating and stabilizing occur at ambient conditions.

11. The method of claim 1, wherein cleaning of the container is substantially accomplished with soap and high purity deionized water.

12. A silver nano-particle colloid produced by:
initiating formation of silver colloid nano-particles by combining a silver nitrate solution and a reduction solution in a container; and
stabilizing the silver colloid nano-particles by combining a stabilizing solution to the container.

13. The silver nano-particle colloid of claim 12, wherein the colloid has a Zeta potential in the range of about −10 to about −50 mV.

14. The silver nano-particle colloid of claim 12, wherein the colloid has a nano-particle diameter in the range of about 10 to about 100 nm.

15. An electrostatic self assembly comprising:
a substrate;
a flexible conductive material formed on the substrate, wherein:
the flexible conductive material comprises at least one silver nano-particle layer and at least one linking agent layer; and
said at least one silver nano-particle layer is bonded to said at least one linking agent layer, and
wherein a size of the at least one silver nano-particle layer is greater than about three square inches.

16. The electrostatic self assembly of claim 15, wherein the substrate is flexible.

17. The electrostatic self assembly of claim 15, wherein the at least one linking agent layer comprises poly(diallyl dimethyl) ammonium chloride.

18. The electrostatic self assembly of claim 15, wherein the at least one linking agent comprises 2-mercaptoethanol.

19. The electrostatic self assembly of claim 15, wherein the at least one linking agent layer comprises poly(allylamine hydrochloride).

20. The electrostatic self assembly of claim 15, wherein the at least one silver nano-particle layer comprises nano-particles having a diameter in the range of about 10 to about 100 nm.
